(19) United States
(12) Patent Application Publication
(10) Pub. No.: US 2014/0352185 A1
(43) Pub. Date: Dec. 4, 2014

(54) INFORMATION DISPLAYS, SYSTEMS AND METHODS

(71) Applicants: Ladd B. Forsline, (US); Bernadette A. Ward, Kutztown, PA (US)

(72) Inventor: Ladd B. Forsline, Kutztown, PA (US)

(21) Appl. No.: 14/275,292

(22) Filed: May 12, 2014

Related U.S. Application Data
(60) Provisional application No. 61/822,164, filed on May 10, 2013.

(51) Int. Cl. G09F 11/02

(52) U.S. Cl. CPC G09F 11/02
USPC 40/486; 40/506

(57) ABSTRACT

An advertising and product information display device. The advertising and product information display device including a rotatable drum presenting a display surface, an elongate shaft coupled to the rotatable drum and extending along the longitudinal axis of the rotatable drum, and a weight component coupled to a portion of the rotatable drum to bias the rotatable drum to a preselected rest position when an external force is removed.

### RELATED APPLICATION INFORMATION

The present application claims the benefit of U.S. Provisional Application 61/822,164, filed May 10, 2013, which is incorporated herein in its entirety by reference.

### TECHNICAL FIELD

The present disclosure relates generally to the field of displays. More particularly, the present disclosure relates to the materials and methods for a rotatable display for advertisements and product information.

### BACKGROUND

Many businesses rely on displays to convey advertising and product information to customers. For example, such displays are often used to depict or describe a product beyond what can be seen from its packaging; including, for example, an intended use of the product. These displays are often placed in traditional retail stores, such as brick and mortar stores, but are also used at pop-up stores, kiosks, trade shows, conventions, and expos. Whatever the context, vendors attempt to display their products or services in a manner that effectively and attractively conveys the advantages of their products or services to potential customers. Various methods are available for this purpose, some of which include displaying advertising or product information on posters, banners, or fliers, such as, for example, as a header on a display case. Some displays use specialized lighting, sound, or mechanized movement to accentuate certain features of the product or service, while other displays simply rely on basic color and design elements to attract customers. Still others offer free samples of the product or items such as pens and key chains advertising the product.

Whatever method is chosen, vendors must promote their products and services so as to capture a potential customer's attention and convince the customer to learn more about their product or service, without confusing or overwhelming the customer with an overload of text and images. It is also important for vendors to use displays that stand out and are distinct from competing products, often located nearby. Furthermore, vendors are aware that many purchases are impulse buys, and in this regard, having a visual edge over the competition can result in increased sales.

Nevertheless, as is well known to those in the product display, retail, and sales industries, that retail space is extremely valuable to retail outlets. For this reason, it is expected that displays that convey advertising and product information accompanying products be designed to take up as little space as possible. Moreover, it is expected that advertizing displays be cost effective, and that the advertizing display not be mechanically complex or require excessive time to assemble and maintain.

What is needed in the industry is a unique display that is simple in design and compactly conveys advertising and product information to potential customers in a manner that is cost-effective and does not overwhelm the customer.

### SUMMARY OF THE DISCLOSURE

The present invention substantially addresses the aforementioned needs of the industry. The present invention is generally directed to devices, systems, and methods for displaying information or communicating to a viewer or potential customer. In one embodiment, the disclosure provides an information display biased to a default position that allows a vendor to present large amounts of information in a manner that does not overwhelm a viewer with an overload of words and images. The information the vendor wishes the viewer to see first can be outwardly facing when the information display is in the biased default position, while other information can be inwardly facing, such that the viewer is required to rotate the information display to access it.

In certain embodiments of the disclosure, an information display device is presented. Such information can be in the form of, although not limited to, advertisements and product information; such as product offerings and inventory, product identification such as product lines, SKUs, reference numbers, graphics, logos, trademarks, trade dress, patent markings, bar codes, QR codes, pricing, contact information, distributor information, and instructional information; educational or instructional information; communication such as directional or informative information, or any of a number of forms of displaying information to a user. In one embodiment, the information display device includes a rotatable drum presenting, an elongate shaft, and a means for biasing the drum to a predefined desired rotation position. In a particular embodiment, the means for biasing comprises a weight component.

The rotatable drum includes a hollow elongate body having a cross section and a length extending along a longitudinal axis. On one embodiment, the cross section is circular, such that the drum is cylindrical in shape. In other embodiments, the cross section is non-circular, and can be any of a variety of shapes such as, for example, triangular, oval, square, rectangular, teardrop, or the like.

A surface of the hollow body presents a display surface. In embodiment, the drum is formed of a transparent material, such as polycarbonate (PC), polyethylene terephthalate (PET), polyvinylchloride (PVC), polymethyl methacrylate (PMMA), polystryrene (PS), clear polypropylene or polyethylene, or combinations thereof. In this embodiment, a printed substrate, such as a sleeve, can be placed within the drum such that the information is viewable through the drum. In an alternative embodiment, the printed substrate is coupled to the exterior surface of the drum, the drum being transparent or opaque. In yet another embodiment, the information is printed directly on an outer and/or inner surface of the drum to form the display surface the drum being transparent or opaque (for example, if printing is on the inner surface, those portions of the drum would preferable be formed of transparent material.

The elongate shaft is coupled to the rotatable drum and extends along at least a portion of the longitudinal axis about which the rotatable drum rotates when an external force is applied. The weight component is coupled to or formed integrally with a portion of the rotatable drum to bias the rotatable drum to a preselected rest position when the external force is removed.

In embodiment, the rotatable drum is centered on the elongate shaft. In an alternative embodiment of the invention, the rotatable drum is offset on the shaft; i.e. the shaft does not extend through the center drum. In this embodiment, the weight component may be optional because the rotatable drum will be automatically biased to a resting position because the weight of the drum is not evenly distributed about the shaft, and it is force by gravity to its lowest point in rotation.

In some embodiments, the invention comprises a horizontally aligned information display that can be rotated by a viewer. In some embodiments, the information display is weighted such that when the viewer is not actively rotating the information display, the weight component can facilitate the rotation of the information display back to a default position, with the weight component being pulled by the force of gravity to its lowest point in the rotation. In other embodiments, the information display is not cylindrical in shape or is not symmetrical in shape, so that a portion of the information display is biased by the force of gravity to its lowest point in the rotation. The default position of the information display is such that the information facing outward can be easily and conveniently viewed by a viewer. As such, the viewer only sees a portion of the information presented. If the viewer decides to rotate the information display, the remaining portion of the information can be presented. Accordingly, using information display, information can be presented to viewers or potential customers that initially contain certain, more general, information; if interested, the viewer or potential customer can subsequently view more information by rotating the information display and viewing or reading the information not initially presented.

In some embodiments, the information display comprises a rotatable drum fixed to a shaft. The drum is coupled to a larger display, such as an advertisement or product display via a mounting bracket for mounting the shaft thereto. The shaft is rotatable with respect to the mounting bracket such that a force applied to either one of the shaft or the drum causes the drum, and therefore the information positioned on the drum, to rotate. In other embodiments, the drum rotates independently of the shaft.

In other embodiments, the information display comprises a drum rotatably attached to a larger information display such that no central shaft is required for the display to rotate around a central axis. For example, the information display can be attached to a larger display via extensions or mounting arms that can be removably coupled to the ends of the information display without the need for a central shaft. The extensions can further comprise bends or junctions that facilitate the attachment of the information display to a larger advertisement or product information display (e.g., a peg board, slat board). The drum is rotatable about the extensions such that a force applied the drum causes the drum, and therefore the information positioned on the drum, to rotate.

In some embodiments, the information display is part of a larger information display, and in such embodiments, the information display can direct a viewer or potential customer to the products surrounding it within the larger information display. In some embodiments, the information display can be manufactured de novo, along with other portions of the larger information display. In other embodiments, the information display can be added to an existing information display (i.e., retrofitted).

In some embodiments, the information can be printed on a poster or other two-dimensional material, or can comprise a flexible digital display, such as an OLED display, which is subsequently wrapped around or mounted within the information display. In such embodiments, the information display can be circular or cylindrical in shape. However, other shapes can be contemplated, such as a drum having, for example, a square, rectangular, tear drop, or triangular cross section.

Embodiments of the disclosure incorporate the advantages of displaying information, such as advertising, on two-dimensional media (e.g., posters, banners, fliers, etc.), including low cost, simplicity, and the ability to include large amounts of information in a small amount of space. In addition, the invention allows large amounts of information to be conveyed in a manner that does not overwhelm a viewer or potential customer with an overload of text and images, and does not take up large amounts of space. The information display also allows the viewer or potential customer to control the content being viewed by rotatable the information display.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a front view of an information display that is part of a larger advertising display in which advertised products, in accordance with an embodiment of the disclosure.

FIG. 2 is a side perspective view of the information display of FIG. 1.

FIG. 3 is a side perspective view of the information display of FIG. 1.

FIG. 4 is a perspective view an information display, in accordance with an embodiment of the disclosure.

FIG. 5 is a side view of the information display of FIG. 4.

FIG. 6 is a top view of the information display of FIG. 4.

FIG. 7 is a perspective view of the drum, shaft and bracket connection of an information display, wherein the shaft is fixedly coupled to the drum in accordance with an embodiment of the disclosure.

FIG. 8 is a perspective view of the drum, shaft and bracket connection of an information display, wherein the shaft is rotatably coupled to the drum in accordance with an embodiment of the disclosure.

FIG. 9 is a front view of an information display that is removably attached to a peg board, in accordance with an embodiment of the disclosure.

FIG. 10 is a side perspective view of the information display of FIG. 9.

While the invention is amenable to various modifications and alternative forms, specifics thereof have by shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Embodiments of the present invention are discussed in detail below. In describing embodiments, specific terminology is employed for the sake of clarity. However, the present invention is not intended to be limited to the specific terminology so selected. A person skilled in the relevant art will recognize that other equivalent parts can be employed and other methods developed without parting from the spirit and scope of the present invention.

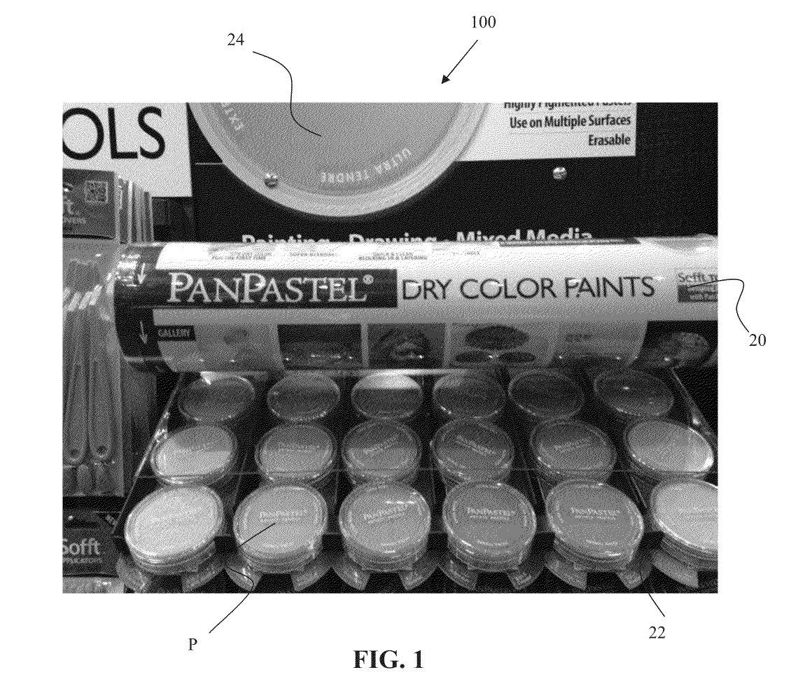

Referring to FIG. 1, information display system 100 comprises horizontally aligned information display 20, as well as product display means 22, such as shelving, racks, etc., for displaying the product P proximate information display 20. An optional header, display, advertisement, or other signage 24 can also be included proximate information display 20 for further display material to catch the consumer's attention or convey product information.

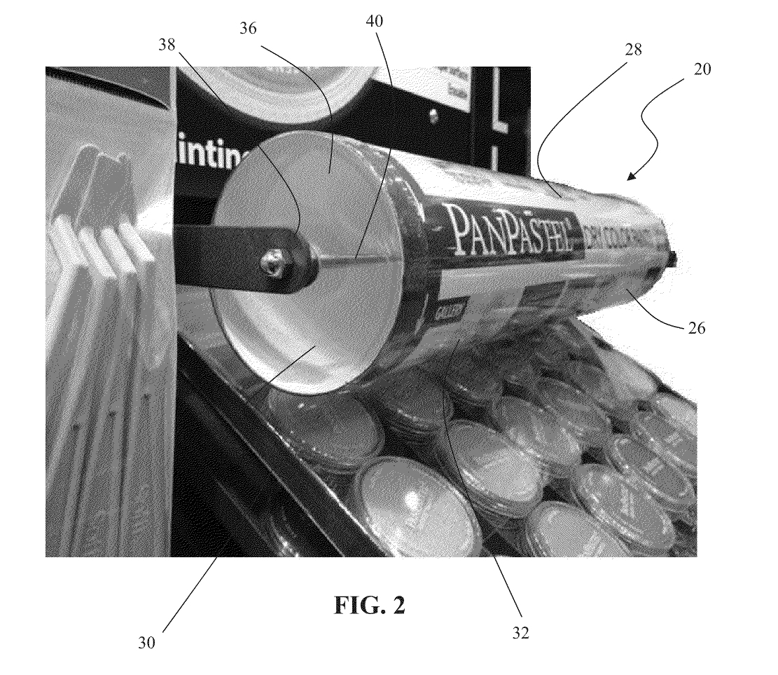

Referring to FIG. 2, in one embodiment, information display 20 comprises horizontally aligned rotatable drum 26. Rotatable drum 26 has an interior surface 30 and an exterior surface 32. In one embodiment, a printed substrate 28 is positioned adjacent an interior surface of drum 30, such that the printed indicia of substrate 28 is viewable through drum 26. A cap 36 is positioned on both ends of drum 26 to secure substrate 28 within drum 26. In some embodiments, each cap 36 has an aperture 38.

In one embodiment, information display 20 comprises a clear or transparent hollow drum 26, having a shaft 40 extending therethrough on which drum 26 is rotatable. Product or display information is printed on a poster or other substrate 28, and is positioned within drum 26 along an interior surface of the drum 30 such that the information is viewable through drum 26 on an exterior surface 32. Optional guide markings or securing means such as adhesive, clips, tabs, or the like can be incorporated on the inside surface 30 to secure the printed substrate 28 thereto to inhibit the substrate 28 from shifting out of position. Caps 36 can optionally be placed on each end or at least one end of drum 26 to further secure the printed substrate 28 within the drum 26 or provide a storage space for supplies such as other printed substrates.

In some embodiments, information display 20 can comprise a variety of materials, including but not limited to, plastic, fiberglass, synthetic polymers, non-synthetic polymers, rubber, composites, glass, metal, wood, cardboard, paper, or combinations thereof. In embodiment, the drum is formed of a transparent material, such as polycarbonate (PC), polyethylene terephthalate (PET), polyvinylchloride (PVC), polymethyl methacrylate (PMMA), polystryrene (PS), clear polypropylene or polyethylene, or combinations thereof.

In one embodiment, the material is transparent such that the information to be displayed can be placed either on an interior surface of drum 26 such that it is viewable through drum 26, and/or on an exterior surface of drum 32. With printed substrate 28 positioned within drum 26, rotating drum 26 allows a viewer to scroll through the information on the substrate 28. In this embodiment, the printed substrate 28 is easily interchangeable with other printed substrates, and one or more printed substrates can optionally be stored within the drum for ease of transport and storage.

In alternative embodiments, information to be displayed can be placed on an exterior surface 32. In such embodiments, drum 26, can be, for example transparent, translucent, or opaque. In one embodiment, printed substrate 28 is secured to an exterior surface of the drum 32. In yet another alternative embodiment, printed indicia or information is printed directly onto drum 26 without the need for a separate printed substrate 28. In still other embodiments, either drum 26 or the substrate 28 mounted either onto or into drum 26 can comprise flexible computer screens or multimedia displays (e.g., OLED).

In some embodiments, drum 26 can have a variety of shapes and dimensions. For example, drum 26 can be circular in cross-sectional shape, such that it rotates symmetrically around a central axis. In other embodiments, drum 26 can be variations of a rounded shape, including cylindrical, oval, teardrop, or oblong. In such embodiments, drum 26 can be biased to return to a default position, such that certain images or information is outwardly facing (i.e., towards a viewer), while other images or information is inwardly facing (i.e., away from a viewer). In other embodiments, drum 26 can be non-rounded, including but not limited to, square, rectangular, triangular, rhomboidal, polygonal, or geometrically irregular in cross-section. In some embodiments, drum 26 can be smaller (e.g., less than 12 inches in circumference), while in other embodiments, drum 26 can be larger (e.g., greater than 12 inches in circumference), depending on the amount of information and images to be displayed, as well as the style of information display system 100.

In some embodiments, shaft 40 passes through at least a portion of the center of the cross-section of the rotatable drum 26 such that drum 26 is centered on shaft 40. In other embodiment, shaft 40 passes through at least a portion of the cross-section of the rotatable drum 26, but at an offset position from the center of the cross-section of the rotatable drum, such that the cross sectional mass of drum 26 is not evenly distributed about shaft 40. In this embodiment, a separate weight element is optional as the unevenly distributed mass automatically biases the drum 26 to its resting position.

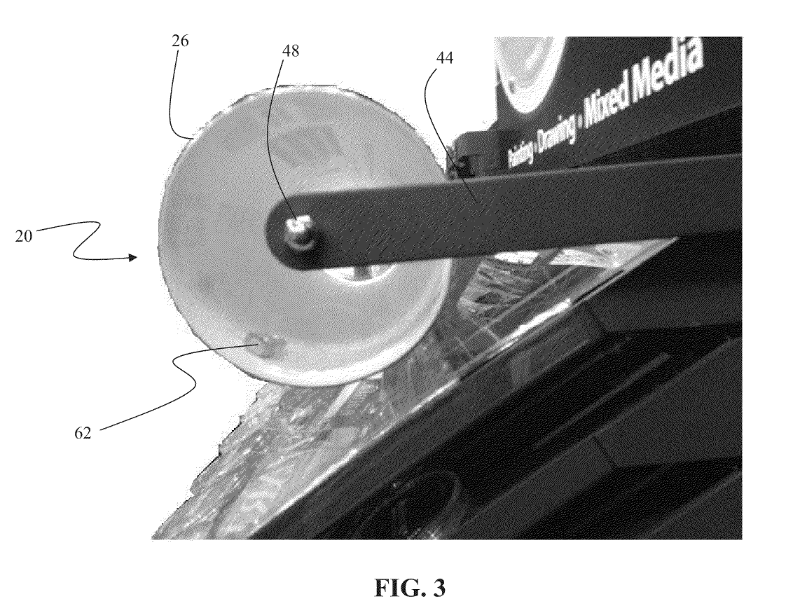

Referring to FIG. 3, in one embodiment, shaft 40 is rotatably mounted to an exterior flange or bracket 44 via mounting hardware 48. In this embodiment, shaft 40 is rotatably mounted to bracket 44 and fixedly mounted to drum 26 such that when a rotational force, either manual or automatic, is applied to drum 26, such as by a user, shaft 40 rotates with respect to bracket 44, thereby causing drum 26 to also rotate.

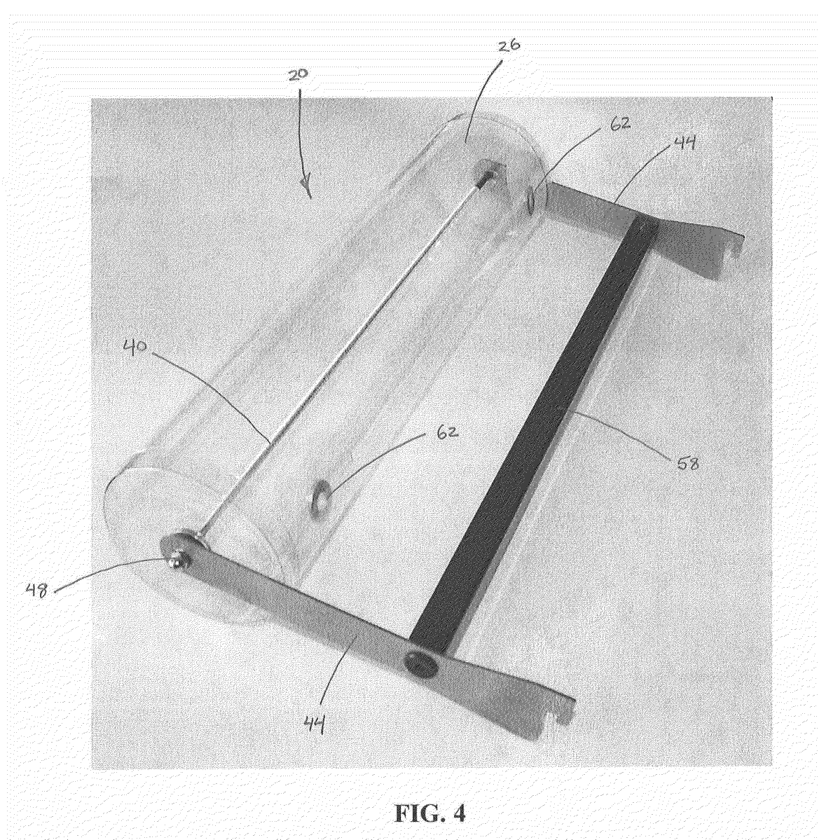

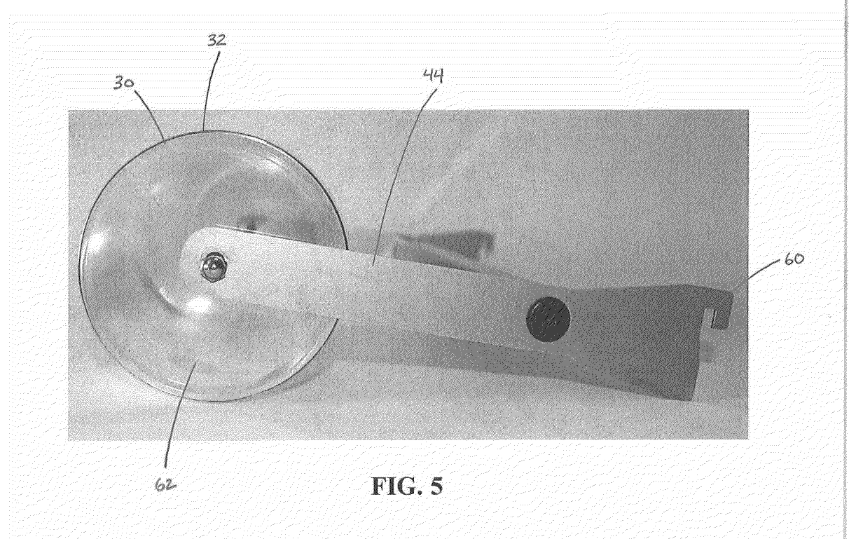

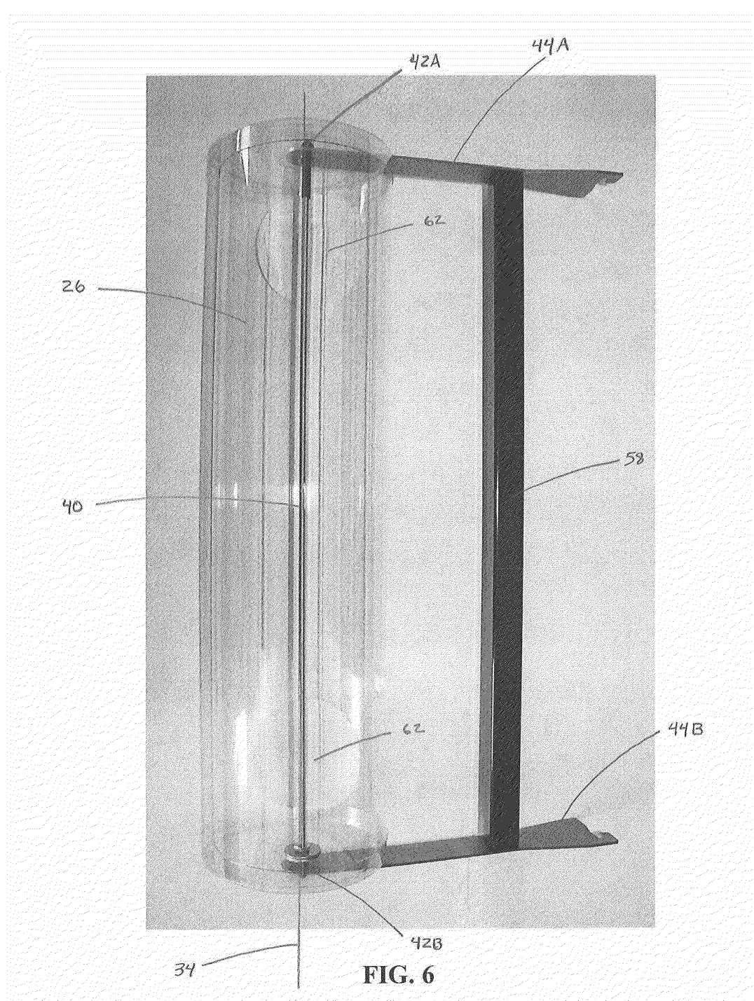

Referring to FIGS. 4-6, in some embodiments, the shaft 40 can be inserted into the center of drum 26, and along a longitudinal axis of drum 34, such that drum 26 rotates symmetrically around longitudinal axis 34. In one embodiment, information display 20 can be comprised of two brackets 44A and 44B fixedly coupled to one another by spacer 58. In one embodiment, brackets 44A and 44B can be substantially parallel to one another, and spacer 58 can be orthogonal to brackets 44A and 44B. Spacer 58 can be sized to retain a predefined spacing between brackets 44A and 44B when shaft 40 and drum 26 are removed.

In some embodiments, mounting brackets 44 can accommodate a variety of mounting hardware in order to secure the information display. In some embodiments, the mounting brackets can comprise movable components, including but not limited to, hinges, hooks, latches, clasps, or combinations thereof. In other embodiments, the mounting brackets can comprise mounting hardware 48 components, including but not limited to, screws, nails, nuts, bolts, or combinations thereof. In some embodiments, mounting brackets can be used such that no mounting hardware is necessary. In one embodiment, bracket 44 can be configured with one or more notches 60 for receiving a portion of product display means 22 (see FIG. 1), thereby retaining advertising and product information display system 100 in position relative to a product display means 22.

In some embodiments, the shaft 40 can be longer than drum 26, such that the ends of shaft 42 extend outwardly from drum 26. In such embodiments, the ends shaft 42 can be detachably coupled to mounting brackets 44 using standard mounting hardware 48. In other embodiments, the shaft 40 can be detachably coupled at one end 42A to a bracket 44 comprising a hinge (not depicted) while the other end of shaft 42B is passively attached to another bracket 44. In such embodiments, hinge can allow shaft 40 to be disengaged from one bracket 44 to facilitate the easy and convenient removal or replacement of drum 26 from the shaft 40.

Information display 20 can further comprise a weight component 62 positioned thereon such that when in a default position, information display 20 conveys a desired portion of the printed information, such as, for example, product P′s registered trademark brand name, or a brief description of product P. In one embodiment, weight component 62 can comprise one or more weight, such as, for example, a weight, affixed to the inner portion or surface of drum 26, which facilitates the rotation of drum 26 to the default position (i.e., weight component 62 is closest to the floor, as dictated by the force of gravity).

With weight component 62 properly utilized, after the viewer is finished accessing that information, information display 20 will automatically rotate back to the default position, based on the position of the weight component 62 within drum 26. For example, the weight component 62 can be affixed to the interior surface of drum 30. In such embodiments, assuming the default position (i.e., the weight component at the lowest point in the rotation of the information display) causes certain advertisements or product information to be outwardly displayed, while causing other advertisements or product information to be inwardly facing. In this manner, the vendor can control what a new viewer initially sees when looking at the display, and can prevent a viewer from being overwhelmed by an overload of text and images.

In some embodiments, the weight component 62 can comprise small weighted objects (e.g., nuts, bolts, sinkers, coins, etc.) affixed to the interior surface of drum 30. In other embodiments, the weight component 62 can comprise long, thin strips of various materials (e.g., plastic, metal, wood, paper, etc.) affixed to the interior surface of drum 30, and running along the length of drum 26. In yet other embodiments, the weight component 62 is integral with drum 26, such as, for example, where shaft 40 is offset from the center of the cross section of drum 26. In this embodiment, the mass distribution of drum 26 will not be centered on shaft 40, and the radial section with the most mass will be biased by the force of gravity to its lowest point in the rotation.

In other embodiments, the weight component 62 is integral with drum 26, such as a weighted side of drum 26 by use of more material (plastic, steel, etc.) in a particular area of the drum 26. In other embodiments, weight component 62 can comprise a plurality of small particles (e.g., sand) that occupy a portion of an inner layer of drum 26. In some embodiments, the weight component 62 can be added to drum 26 after it has been constructed (i.e., retrofitted), while in other embodiments, weight component 62 can be constructed along with drum 26 such that they are coupled together.

In still other embodiments, the weight component 62 can comprise a portion of printed substrate 28. In such embodiments, the weight component 62 can comprise a portion of printed substrate 28 that is thicker or heavier, in relation to the other portions of the printed substrate 28.

In one embodiment (not shown), a substrate mounted within drum 26 comprises a flexible electronic digital display, such as an OLED display. A power source, such as a battery, for powering the display, is affixed to the drum such that not only does it provide power to the display, but also acts as the weight component.

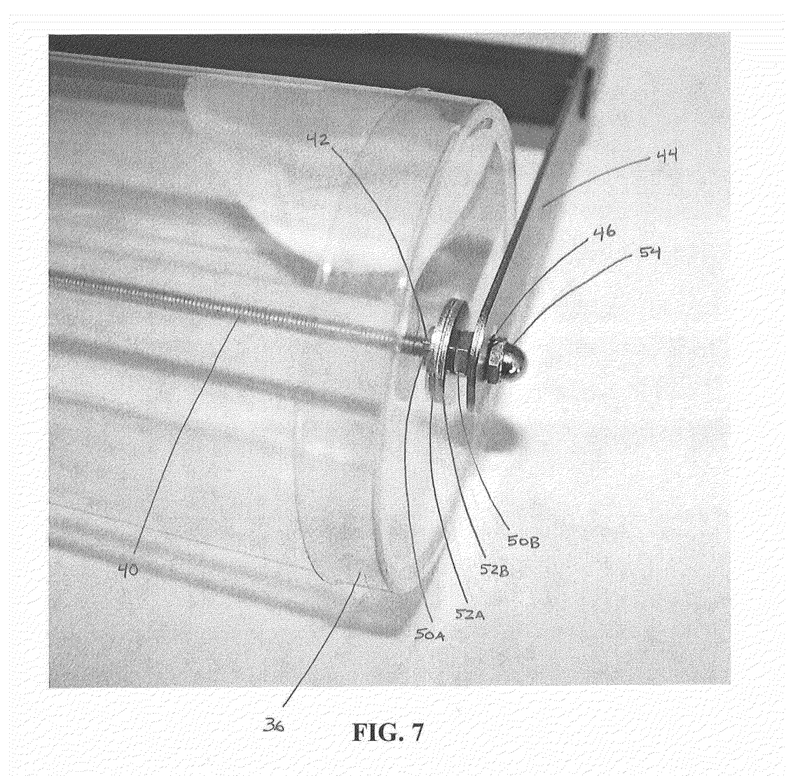

Referring to FIG. 7, in one embodiment, mounting hardware 48 comprises locking devices 50A and 50B, washers 52A and 52B, and end locking device 54. In this embodiment, washers 52A and 52B are positioned on shaft 40 on either side of cap 36, thereby sandwiching cap 36 between washers 52A and 52B. Locking devices 50A and 50B are positioned adjacent to washers 52A and 52B and, in one embodiment are threadedly tightened to secure washers 52A and 52B and cap 36 in position. In one embodiment, end locking device 54 is threadedly coupled to the end of shaft 42, as shaft 40 passes through aperture 38 in cap 36, for the purpose of securing shaft 40 to bracket 44 in a manner that allows shaft 40 to freely rotate relative to bracket 44. In other embodiments, locking devices 50A and 50B and end locking device 54 can be coupled to shaft 40 by a set screw, friction fitting, or other means.

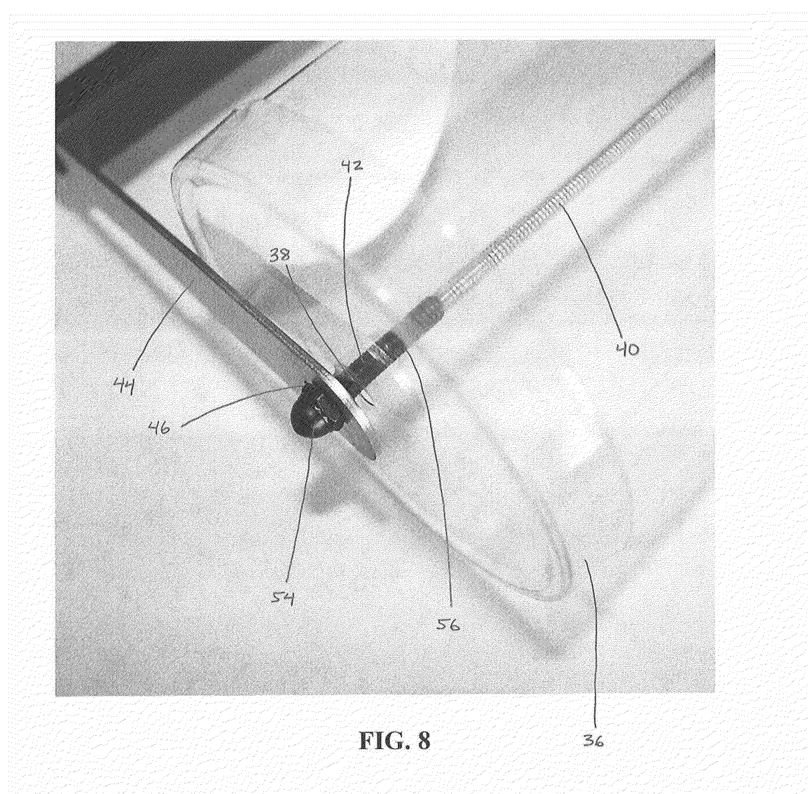

Referring to FIG. 8, in another embodiment, shaft 40 is fixedly mounted to bracket 44 via mounting hardware 48. In this embodiment, shaft 40 is fixedly mounted to bracket 44 such that shaft 40 does not rotated with respect to bracket 44, and shaft 40 is rotatably mounted to drum 26 such that when a rotational force, either manual or automatic, is applied to drum 26, drum 26 rotates relative to shaft 40. In one embodiment, mounting hardware 48 comprises end locking device 54 and wrapping 56, such as, for example, a sleeve of heat shrink material. In one embodiment, end locking device 54 is threadedly coupled to one end of shaft 40, as shaft 40 passes through aperture 38 in cap 36, for the purpose of securing shaft 40 to bracket 44. In other embodiments, end locking device 54 can be coupled to shaft 40 by a set screw, friction fitting, or other means. Wrapping 56 is positioned around shaft 40 where shaft 40 extends within and through caps 36 to reduce wear and eliminate travel of drum 26 on threads of shaft 40.

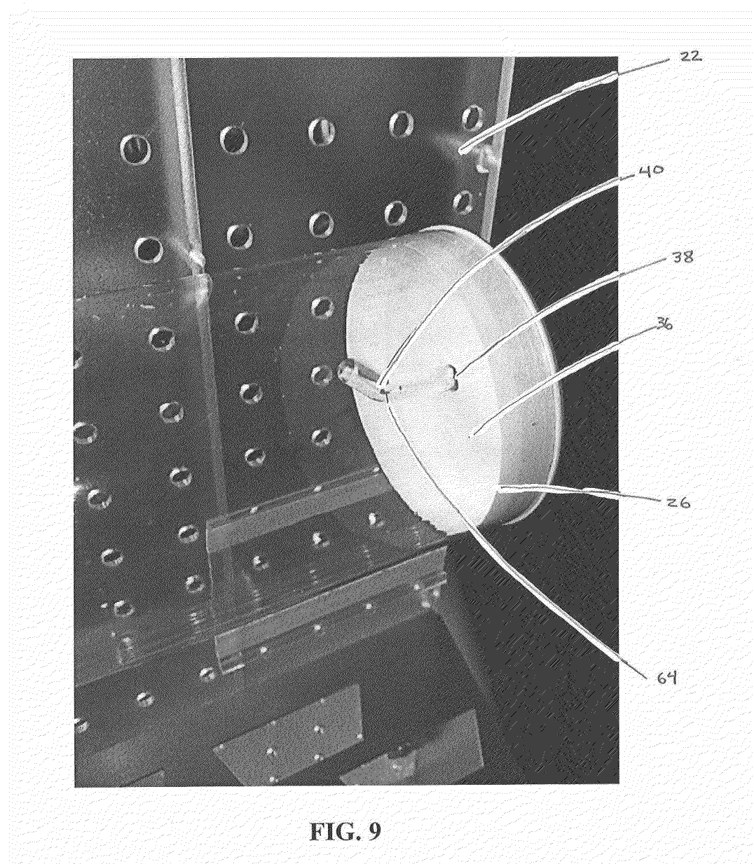

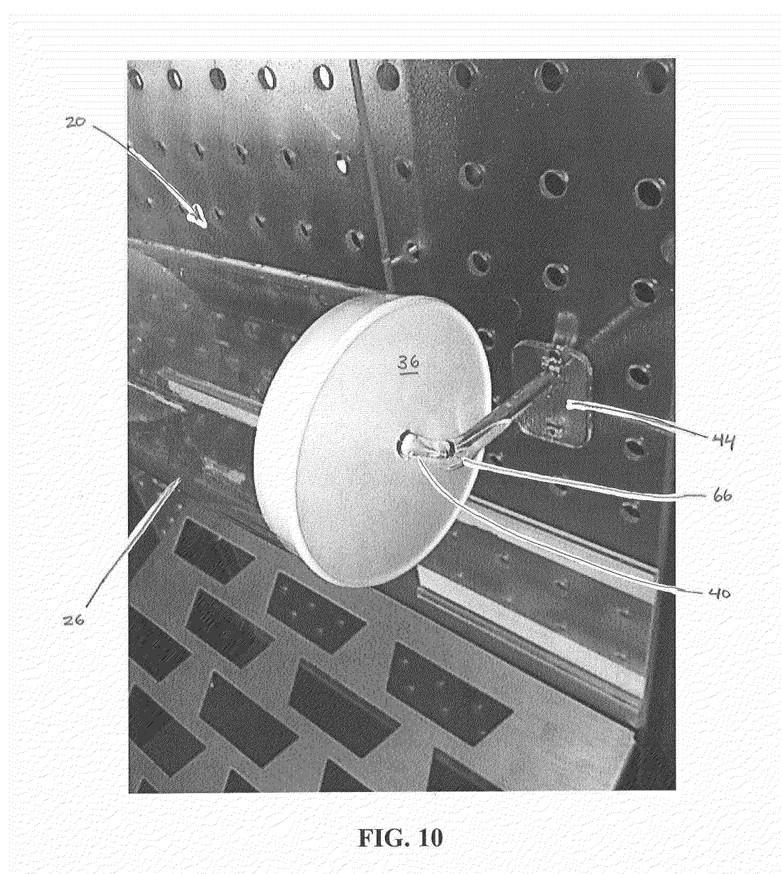

Referring to FIGS. 9 and 10, in some embodiments, mounting bracket 44 alone can be used to secure the drum 26, without the need for the central shaft. For example, the mounting brackets 44 can comprise convex structures or cantilevered arms that extend proximally from the bracket and fit inside concave depressions located at either end of the information display 20. In other embodiments, the mounting brackets can comprise an extension that can be removably coupled to the ends of the information display (i.e., inserted into caps at each end of the information display), without the need for a central shaft. In such embodiments, the extensions can comprise bends or junctions that facilitate the attachment of the information display to a product display means 22, such as peg board.

In one embodiment, information display 20 comprises drum 26 and at least one cap 36, positioned the end of drum 26. In some embodiments, cap 36 is removably and rotatably coupled to mounting arm 40, wherein arm 40 does not extend the length of information display 20, but instead extends only a short distance (for example 2-3 inches) into the inside of drum 26, where it further comprises internal bend 64 to secure drum 26 thereto. Mounting arm 40 comprising external bend 66, which can be about 90 degrees, such that bend 66 enables mounting arm 40 to permanently or removably couple to product display means 22, such as a larger advertising and product information display system via mounting bracket 44. For example, product display means 22 can comprises a pegboard having a plurality of apertures and mounting bracket 44 comprises a plurality of protrusions receivable within the apertures of the pegboard. In another embodiment (not shown), product display means 22 comprises a slat wall, and the mounting bracket comprises the appropriate corresponding flange, extensions, shoulder, or other extension receivable and mountable to the support surface.

In operation, according to one particular non-limiting embodiment, printed substrate 28, such as a poster, having product information thereon, such as instructions, graphics, logos, product formulation or ingredients, pricing, demonstrations, or any of a variety of information and combinations thereof, is inserted within the hollow rotatable drum 26. Optional guide marks can be incorporated for alignment of the poster within the drum 26. Once printed substrate 28 is aligned in the optional position, printed substrate 28 can be secured to the interior of drum 26 via adhesive, clips, tape, notches within the drum 26, or any of a variety of suitable securing means. Weigh component 310 is secured in a desired position on an interior surface of the drum 26. End caps 36 are placed on each end of the drum 26.

Shaft 40 is inserted into an aperture or bore 38 defined in one end cap 36 and is threaded through the hollow interior of the drum and out of a bore 38 defined in the other end cap 36 such that shaft 40 extends along a longitudinal axis of the drum 26. Optionally one or more washers 52 are placed on each end of the shaft 40. Each end of the shaft 40 is then inserted into and through an aperture of a flange of a mounting bracket 44. An end locking device 54 is secured on each end of shaft 40 to secure shaft 40 and drum 26 to the mounting bracket 44.

Upon an external force, such as a hand of a viewer, drum 26 rotates with respect to mounting bracket 44 via shaft 40 to allow the user to scroll through the information printed on printed substrate 28. Upon removal of the force, weight component 310, via gravity, manipulates drum 26 back to a desired default position. In alternative embodiments, shaft 40 can be rotated directly or via a handle (not depicted) coupled to the shaft 40, thereby causing the drum 26 to rotate. In yet other alternative embodiments, the rotation of the drum 26 is automatic, such as by use of a motor. The rotation can be constant, or actuated by the user (e.g. push button actuated).

Additionally, information display system 100 generally comprises a means for mounting the information display 20 within a larger product display means 22, such that information display 20 can be rotated by a viewer in order to view information, such as product identification, instructions, use or demonstrations, pricing information, or the like, printed on information display system 100. In some embodiments, a single information display 20 can be used, while in other embodiments, a plurality of information displays 20 can be used, in which case the plurality of information displays 20 can function coordinately. In some embodiments, the information displays 20 can be generally horizontal with respect to the ground, or information displays 20 can be arranged at various angles, including vertical angles. In an alternative embodiment of the invention, information displays 20 can be generally vertical with respect to the ground.

What is claimed is:

1. An information display device comprising:
a rotatable drum having an interior and exterior surface, and presenting a length and a cross-section; and
an elongate shaft coupled to the rotatable drum about which or with which the rotatable drum rotates when an external force is applied;
wherein the information display device further comprises a weight component to bias the rotatable drum to a preselected rest position when the external force is removed.

2. The information display device of claim 1, wherein the information display device further comprises a printed substrate selectively coupleable to the rotatable drum, the printed substrate having printed indicia thereon.

3. The information display device of claim 2, wherein at least a portion of the rotatable drum is transparent.

4. The information display device of claim 3, wherein a printed substrate is coupleable to the interior surface of the rotatable drum such that printed indicia is viewable through the exterior surface of the rotatable drum.

5. The information display device of claim 4, wherein the printed substrate is secured within the rotatable drum by a cap selectively secured to an end of rotatable drum.

6. The information display device of claim 2, wherein the printed substrate is coupleable to the exterior surface of the rotatable drum.

7. The information display device of claim 1, wherein printed indicia is applied directly on the exterior surface of the rotatable drum.

8. The information display device of claim 1, wherein the rotatable drum has a substantially circular cross-section.

9. The information display device of claim 1, wherein the rotatable drum has a cross sectional shape selected from the group consisting of a circle, oval, teardrop, square, rectangle, triangle, rhombus, and polygon.

10. The information display device of claim 9, wherein the rotatable drum is centered on the elongate shaft such that a portion of the elongate shaft extends through a center of an end of the rotatable drum.

11. The information display device of claim 9, wherein the rotatable drum is not centered on the elongate shaft such that a portion of the elongate shaft extends through an end of the rotatable drum at a position offset from the center of the end of the rotatable drum.

12. The information display device of claim 11, wherein the weight component comprises an offset center of mass of the rotatable drum.

13. The information display device of claim 1, wherein the weight component comprises one or more weighted elements selectively coupled to the interior surface of the rotatable drum.

14. An information display system comprising:
a display assembly for displaying one or more products;
an information display device coupled to the display assembly, the information display device comprising:
a rotatable drum having an interior and exterior surface, and presenting a length and a cross-section; and
an elongate shaft coupled to the rotatable drum about which or with which the rotatable drum rotates when an external force is applied;
wherein the rotatable drum further comprises means for biasing the rotatable drum to a preselected rest position when the external force is removed; and
signage displaying information positioned proximate the one or more information display device.

15. The information display system of claim 14, wherein the information display device further comprises a printed substrate having printed indicia thereon, the printed substrate being selectively coupleable to the rotatable drum.

16. The information display system of claim 14, wherein printed indicia is applied directly on the exterior surface of the rotatable drum.

17. The information display system of claim 14, wherein the rotatable drum has a substantially circular cross-section.

18. The information display system of claim 14, wherein the rotatable drum has a cross sectional shape selected from the group consisting of a circle, oval, teardrop, square, rectangle, triangle, rhombus, and polygon.

19. The information display system of claim 14, wherein the rotatable drum is centered on the elongate shaft such that a portion of the elongate shaft extends through a center of an end of the rotatable drum, and wherein the means for biasing comprises a weight component.

20. The information display system of claim 19, wherein the weight component comprises an offset center of mass of the rotatable drum.

21. The information display system of claim 19, wherein the weight component comprises one or more weighted elements selectively coupled to the interior surface of the rotatable drum.

22. The information display system of claim 14, wherein the rotatable drum is not centered on the elongate shaft such that a portion of the elongate shaft extends through an end of the rotatable drum at a position offset from the center of the end of the rotatable drum, such that the means for biasing comprises an uneven mass distribution about the elongate shaft.

23. An information display method utilizing an information display, the method comprising:
providing a rotatable drum presenting a longitudinal axis, and an elongate shaft coupled to the rotatable drum and substantially parallel to the longitudinal axis on which or with which the rotatable drum rotates when an external force is applied
positioning a printed substrate either on an external display surface of the rotatable drum, or within the rotatable drum such that the printed substrate is viewable through the display surface; and
coupling a weight component to a portion of the rotatable drum to bias the rotatable drum to a preselected rest position when the external force is removed.
